(19) United States
(12) Patent Application Publication
(10) Pub. No.: US 2025/0113333 A1
(43) Pub. Date: Apr. 3, 2025

(54) Operations Based on Characteristics of a Physical Environment

(71) Applicant: Apple Inc., Cupertino, CA (US)

(72) Inventors: Vignesh Babu MOORTHY, San Jose, CA (US); Benjamin A WERNER, San Jose, CA (US); Kenneth M PESYNA, JR., San Jose, CA (US); Robert W BRUMLEY, San Jose, CA (US)

(21) Appl. No.: 18/884,249

(22) Filed: Sep. 13, 2024

Related U.S. Application Data
(60) Provisional application No. 63/586,659, filed on Sep. 29, 2023.

(51) Int. Cl. H04W 64/00; H04B 1/7163; H04W 84/12

(52) U.S. Cl. CPC H04W 64/006; H04B 1/7163; H04W 84/12

(57) ABSTRACT

An apparatus configured to generate, for transmission to a wireless communication device, a request to initiate a ranging operation, process, based on one or more signals received from the wireless communication device, a response indicating that the apparatus is to locate the second wireless communication device, determine information corresponding to physical environmental conditions of the apparatus or the wireless communication device and select one or more find location techniques to use for generating a graphic to be displayed on a display device based on at least the information corresponding to the physical environmental conditions of the apparatus or the wireless communication device, the graphic indicating a direction of the wireless communication device relative to the apparatus.

### PRIORITY/INCORPORATION BY REFERENCE

This application claims priority to U.S. Provisional Application Ser. No. 63/586,659 filed on Sep. 29, 2023, entitled “People Finding Based on Characteristics of a Physical Environment,” the entirety of which is incorporated by reference herein.

### BACKGROUND

There are various mechanisms that allow wireless communication devices to locate one another. Some mechanisms may use these features to dynamically generate directions that enable a user of one device to locate another device. For example, a first wireless communication device may determine the location of a second wireless communication device relative to the first wireless communication device. The first wireless communication device may then generate directions that enable the user of the first wireless communication to find the precise location of the second wireless communication device.

The physical environment of the wireless communication devices may have an effect on the accuracy of the directions. Inaccurate directions lead to confusion and a poor user experience. Accordingly, it has been identified that there is a need for mechanisms that consider the characteristics of a physical environment of the wireless communication devices when generating directions that enable a user of one device to locate another device.

### SUMMARY

Some example embodiments are related to an apparatus having processing circuitry configured to generate, for transmission to a wireless communication device, a request to initiate a ranging operation, process, based on one or more signals received from the wireless communication device, a response indicating that the apparatus is to locate the second wireless communication device, determine information corresponding to physical environmental conditions of the apparatus or the wireless communication device and select one or more find location techniques to use for generating a graphic to be displayed on a display device based on at least the information corresponding to the physical environmental conditions of the apparatus or the wireless communication device, the graphic indicating a direction of the wireless communication device relative to the apparatus.

Other example embodiments are related to a method performed by an apparatus, the method including generating, for transmission to a wireless communication device, a request to initiate a ranging operation, processing, based on one or more signals received from the wireless communication device, a response indicating that the apparatus is to locate the second wireless communication device, determining information corresponding to physical environmental conditions of the apparatus or the wireless communication device and selecting one or more find location techniques to use for generating a graphic to be displayed on a display device based on at least the information corresponding to the physical environmental conditions of the apparatus or the wireless communication device, the graphic indicating a direction of the wireless communication device relative to the apparatus.

### BRIEF DESCRIPTION OF THE DRAWINGS

FIG. 1 shows an example arrangement according to various example embodiments.

FIG. 2 shows an example wireless communication device according to various example embodiments.

FIG. 3 shows a method for performing a find location operation between the first wireless communication device and the second wireless communication device according to various example embodiments.

FIG. 4 shows an example architecture for a finder and findee according to various example embodiments.

FIG. 5 shows examples of an arrow directing the finder to the findee according to various example embodiments.

FIG. 6 shows a method for arrow generation according to various example embodiments.

### DETAILED DESCRIPTION

The example embodiments may be further understood with reference to the following description and the related appended drawings, wherein like elements are provided with the same reference numerals. The example embodiments relate to mechanisms that enable a user of one wireless communication device to locate another wireless communication device and/or user thereof.

The example embodiments are described with regard to wireless communication devices. As will be described in greater detail below, the wireless communication devices may include any electronic component configured with the hardware, software, and/or firmware to establish a short-range wireless connection to another wireless communication device and communicate with a network.

Some example embodiments include the use of short-range communication connections. In some examples, a short-range communication connection may be a Bluetooth connection, e.g., Bluetooth Classic, Bluetooth Low-Energy (BLE), etc. This is only an example and the principles described herein for the example embodiments may be applied to other types of short-range communication connections. Therefore, any reference to terms such as, “Bluetooth,” “Bluetooth connection,” “short-range communication protocol,” “short-range connection,” or “short-range communication link” are provided for illustrative purposes and not intended to limit the example embodiments to any particular type of wireless communication protocol.

Some example embodiments include the use of ultra-wideband (UWB) communication connections. Other example embodiments include the use of cellular network connections or another wireless network connection such as a wireless local area network (WLAN) or a wide area network (WAN).

The example embodiments are also described with reference to a finder and a findee. In this context, the “findee” may generally refer to the wireless communication device and/or user thereof that is sharing their location with others. The “finder” may generally refer to the wireless communication device and/or user thereof that receives location information from another user. To provide a non-limiting example, a finder may receive information from the findee that is used to determine the direction of the findee relative to the finder.

The finder may dynamically output directions that enable its user to navigate to the precise location of the findee. In some examples, the directions may include a graphic such as an arrow displayed on a user interface (UI) of an application. The arrow may point in the direction of the findee relative to the location and/or pose of the finder. This may allow the user to move through a crowded environment and locate findee. However, the arrow is only one example of a type of indication that may be used to convey directions to the user and the principles described herein for the example embodiments may be applied to other types of indications that may be used to direct a finder towards a findee.

The finder may generate directions towards the findee based on information collected from any of a variety of different sources. To provide some non-limiting examples, the finder may use information collected by cameras and sensors, global positioning system (GPS) location information, information received directly from the finder, information received indirectly from the finder via a network, ultra-wide band (UWB) ranging and/or information derived based on communication with the findee.

The example embodiments are described regarding the physical environment (e.g., one or more environmental conditions) of the finder and/or findee. A physical environment of a wireless communication device (e.g., finder) may affect its ability to generate precise and/or accurate directions for finding another wireless communication device (e.g., findee). Further, the physical environment of the wireless communication device being searched for (e.g., findee) may affect the ability of the wireless communication device that is searching (e.g., finder). For example, in an indoor environment, GPS information may be inaccurate which may lead to inadequate directions towards the findee if GPS information is used to locate the findee. In another example, a camera or sensor of the finder may not be able to collect adequate information about a crowded environment beyond a certain distance which may lead to inadequate directions when the finder and findee are outside of a certain range. Inaccurate, imprecise, and/or inadequate directions may create confusion and a poor user experience.

To limit the occurrence of imprecise, inaccurate and/or inadequate directions, the finder may not provide explicit directions towards the findee under certain conditions. For example, in a crowded indoor setting, the finder may not display an arrow pointing towards the findee until the finder is located within (X) meters of the findee. In an outdoor setting, the finder may not display an arrow pointing towards the findee until the finder is located within (Y) meters of the findee. The range thresholds may be used to ensure that if directions are displayed to the user, the directions are reliable and accurate and may be within a threshold of precision.

According to some aspects, the example embodiments generate directions towards the findee using different techniques depending on characteristics of, or parameters related to, the physical environment of the finder, the findee or both. Continuing with the example provided above, in a crowded indoor setting, the finder may not use GPS information because GPS information may be inaccurate when used indoors. In the outdoor setting, the finder may use GPS information because it is more reliable outdoors. Where the finder is using different techniques in different physical environments, the range thresholds (e.g., X and Y) may vary.

From a user experience perspective, it is beneficial to have different range thresholds in different physical environments instead of a static range threshold applicable to all environments. For example, in a sparsely populated outdoor setting (e.g., beach, park, field, etc.), it may be helpful to have wider locating capabilities and thus, it may be beneficial to use GPS information to increase the range at which adequate directions may be generated by the finder. However, not only may GPS information be unreliable in an indoor setting the longer range may be unnecessary for an indoor use case. Therefore, it may be unnecessary and possibly detrimental to use the GPS information indoors. The above examples are provided for illustrative purposes and are not intended to limit the example embodiments in any way. Specific example embodiments are described in detail below. The example embodiments introduced herein may be used independently from one another, in conjunction with other currently implemented people finding/device finding mechanisms, in conjunction with future implementations of people finding/device finding mechanisms or independently from other people finding/device finding mechanisms.

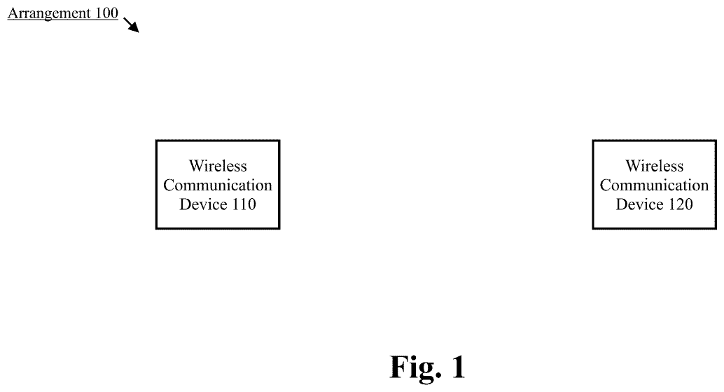

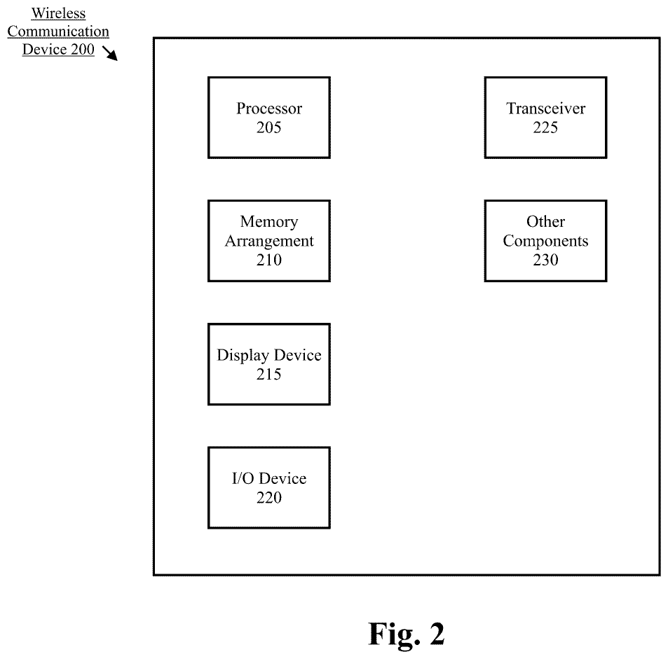

FIG. 1 shows an example arrangement 100 according to various example embodiments. The example arrangement 100 includes a first wireless communication device 110 and a second wireless communication device 120. Examples of these wireless communication devices 110 and 120 will be described in greater detail below with regard to FIG. 2. In the example of FIG. 1, the first wireless communication device 110 and the second wireless communication device 120 may not currently have a direct connection to each other.

In this example, the user of the first wireless communication device 110 may wish to locate the user of the second wireless communication device 120. As will be described in greater detail below, the users of the first and second wireless communication devices 110 and 120 may form a relationship that allows the first and second wireless communication devices 110 and 120 to find each other. In the example of the user of the first wireless communication device 110 wishing to locate the user of the second wireless communication device 120, the second wireless communication device 120 and/or user thereof may be considered to be the “findee,” (e.g., sharing their location with others) and the first wireless communication device 110 and/or user thereof may be considered to be the “finder,” e.g., receiving location information from another user.

In non-limiting examples, the finder 110 may move towards the findee 120; in other scenarios the finder 110 and the findee 120 may both be moving. In some examples, the finder 110 may be above or below the findee 120. For instance, in a building with multiple levels or floors, or in an outdoor environment at a different elevation. One of skill in the art will appreciate that numerous combinations of wireless communication devices 110 and 120 may be used in the example finding scenarios (phone/phone watch/phone, phone/tablet, phone/headset, etc.).

FIG. 2 shows an example wireless communication device 200 according to various example embodiments. The wireless communication device 200 of FIG. 2 may represent the wireless communication device 110 or 120 described with regard to FIG. 1. The wireless communication device 200 may be any type of electronic component that is configured to wirelessly connect to another wireless communication device. A wireless connection may be a short-range communication connection. Non-limiting examples include mobile phones, smartphones, tablet computers, desktop computers, wearables, embedded devices, Internet of Things (IoT) devices, etc.

The wireless communication device 200 may include a processor 205, a memory arrangement 210, a display device 215, an input/output (I/O) device 220, a transceiver 225, and other components 230. The other components 230 may include, for example, an audio input device, an audio output device, a data acquisition device, cameras, sensors for visual inertial odometry (VIO), inertial measurement units (IMUs), light detection and ranging (LiDAR) sensors, ports to electrically connect to other electronic devices, sensors to detect conditions of the device, etc.

The processor 205 may be configured to execute a plurality of engines for the wireless communication device 200. For example, the engines may perform operations related to locating another wireless communication device such as, but not limited to, deriving location and motion data for the finder, deriving location and motion data for the findee, deriving information about the physical environment of the finder and/or findee, generating directions that enable the user of the wireless communication device 200 to locate another device and selected techniques for generating directions towards the findee based on characteristics of the physical environment. Examples of these operations will be described in greater detail below.

The above referenced engines being an application (e.g., a program) executed by the processor 205 is only an example. The functionality associated with the engines may also be represented as a separate incorporated component of the wireless communication device 200 or may be a modular component coupled to the wireless communication device 200, e.g., an integrated circuit with or without firmware. For example, the integrated circuit may include input circuitry to receive signals and processing circuitry to process the signals and other information. The engines may also be embodied as one application or separate applications. In addition, in some wireless communication devices, the functionality described for the processor 205 is split among two or more processors such as a baseband processor and an applications processor. The example embodiments may be implemented in any of these or other configurations of a wireless communication device.

The memory arrangement 210 may be a hardware component configured to store data related to operations performed by the wireless communication device 200. The display device 215 may be a hardware component configured to show data to a user, e.g., display user interfaces (UIs), directional arrows, text messages, etc. The I/O device 220 may be a hardware component that enables the user to enter inputs (e.g., to locate another person, to allow find location services to be used, etc.). The display device 215 and the I/O device 220 may be separate components or integrated together such as a touchscreen.

The transceiver 225 may be a hardware component configured to establish a wireless connection with one or more networks or with one or more other wireless communication devices. The transceiver 225 may be configured to use more than one radio access technology (e.g., cellular, wireless local area network (WLAN), etc.). Accordingly, the transceiver 225 may operate on a variety of different frequencies or channels (e.g., set of consecutive frequencies) to communicate with the networks and/or other wireless communication devices. The transceiver 225 may also be configured to use a short-range communication protocol, e.g., Bluetooth. The transceiver 225 may also be configured to receive GPS signals from one or more satellites. The transceiver 225 may include separate transceiver circuitry for each of a respective type of wireless connection, radio access technology, and/or range of frequencies of operation. The transceiver 225 may comprise transceiver circuitry configured for operating using Bluetooth communication. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

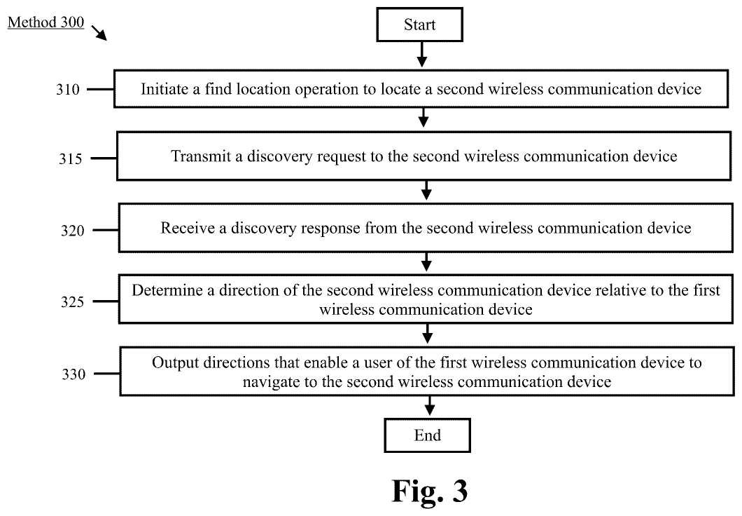

FIG. 3 shows a method 300 for performing a find location operation between the first wireless communication device 110 and the second wireless communication device 120 according to various example embodiments. In this example, the first wireless communication device 110 may be the finder and the second wireless communication device 120 may be the findee.

In 310, the first wireless communication device 110 initiates a find location operation to locate the second wireless communication device 120. As will be described in greater detail below, the find location operation may be used by the first wireless communication device 110 to generate directions that enable the user of the first wireless communication device 110 to navigate to the precise location of the second wireless communication device 120. The directions may consist of displaying an arrow on the user interface (UI) of an application running on the first wireless communication device 110 that points in the direction of the second wireless communication device 120. The arrow may automatically update its orientation based on the location of the first wireless communication device 110 relative to the second wireless communication device 120.

Prior to the first wireless communication device 110 initiating the find location operation for the second wireless communication device 120, the devices 110-120 and/or the users thereof may have communicated their intentions to form a friendship relationship. Throughout this description, a friendship relationship refers to a configuration where one wireless communication device is permitted to find another wireless communication device using the find operation. For example, the first wireless communication device 110 may be permitted to locate the second wireless communication device 120. The second wireless communication device 120 may be permitted to locate the first wireless communication device 110. The friendship relationship between the first wireless communication device 110 and the second wireless communication device 120 may encompass a state of i) only the first wireless communication device 110 is permitted to operate as a finder and only the second wireless communication device 110 is permitted to operate as a findee, ii) only the second wireless communication device 120 is permitted to operate as a finder and only the first wireless communication device 110 is permitted to operate as a findee or iii) there is a reciprocal relationship where both the first wireless communication device 110 and the second wireless communication device 120 are permitted to operate as a finder and findee. However, reference to the term “friendship relationship” is merely provided for illustrative purposes. Different entities may refer to this concept by a different name.

To provide a general non-limiting example, the wireless communication devices may have a find location application and the users may enter their intention to form a friendship via a UI of the application. Subsequently, the wireless communication device 120 and the first wireless communication device 110 may share one or more keys that are used to enable communication between the devices during a find operation. The one or more keys may be exchanged between the first wireless communication device 110 and the second wireless communication device 120 directly using short-range communication or indirectly using a network connection.

In some embodiments, a key associated with the friendship relationship may be a one-to-one key, e.g., the key is unique to the finder/findee friendship and only the friendship pair will know this friendship key and no other device can resolve the finder or findee using the specific friendship key. The users sharing their location may revoke that permission at any time, either offline (e.g., by disabling a specific friendship key) or online (e.g., by indicating to the finder that the friendship key is no longer active). However, reference to a key mechanism is merely provided for illustrative purposes. The example embodiments may utilize any appropriate type of mechanism to manage the settings with regard to the finder and findee relationship between two or more devices.

In 315, the first wireless communication device 110 transmits to the second wireless communication device 120, one or more signals including a request to initiate a ranging operation. The request may include data related to finding the second wireless communication device 120. For example, the request may include data that is encrypted using a key known to the finder and findee. In some examples, the request may be a Bluetooth advertisement.

After transmitting the request, the first wireless communication device 110 may receive one or more signals from the second wireless communication device 120 that comprises a response indicating that the first wireless communication device 110 is to locate the second wireless communication device 120. The first wireless communication device 110 (e.g., processor) may decode a request based on one or more signals transmitted by the second wireless communication device 120 over a cellular or WiFi network.

In some examples, after transmitting a Bluetooth advertisement comprising the request, the first wireless communication device 110 may perform scanning operations to determine if the second wireless communication device 120 has responded to the Bluetooth advertisements. Like the advertisement operation, the operations may be performed continuously until the findee is located or the user of the finder discontinues attempting to locate the findee.

Prior to 310 or 315, on the findee side, the second wireless communication device 120 may scan for Bluetooth advertisements from other wireless communication devices that are attempting to find the second wireless communication device 120. The scanning operation may be any scanning operation supported by the Bluetooth protocol being executed by the findee. The findee may be triggered to perform the scanning operations for any of a variety of different reasons (e.g., in accordance with a schedule, triggered by a predetermined condition, in response to user input, etc.). In addition, the scanning operations may be performed when the findee is offline, e.g., has no connection to a wireless network and/or in a power saving mode. The scanning operation may be continuous until the user of the findee turns off this capability or until the findee has identified a finder (e.g., first wireless communication device 110). These scanning examples are only provided for illustrative purposes and any appropriate type of scanning operation may be used.

In 320, the first wireless communication device 110 receives a Bluetooth advertisement from the second wireless communication device 120. In this example, it may be assumed that the second wireless communication device 120 received a Bluetooth advertisement transmitted by the first wireless communication device 110 in 315. The second wireless communication device 120 may determine, based on the advertisement and the state of their friendship relationship, that the first wireless communication device 110 is permitted to locate the second wireless communication device 120 using the find operation. The second wireless communication device 120 may then transmit one or more Bluetooth advertisements to the first wireless communication device 110 where at least one Bluetooth advertisement is received in 320. Therefore, the Bluetooth advertisement in 320 may indicate that the second wireless communication device 120 received a Bluetooth advertisement from the first wireless communication device 110 for the find operation.

The exchange of Bluetooth signals in 315-320 may allow the finder and the findee to discover each other's presence and confirm that the finder it permitted to locate the findee. After this exchange, a more precise location operation may be performed. For example, an ultra-wideband (UWB) ranging operation may be used to determine a more precise location of the findee.

In 325, the first wireless communication device 110 determines a direction of the second wireless communication device 120 relative to the first wireless communication device 110. For example, as mentioned above, the first wireless communication device 110 may perform a UWB ranging operation to determine the direction of the second wireless communication device 120. Alternatively, or in addition to the UWB ranging operation, the first wireless communication device 110 may use other information collected by other components of the first wireless communication device 110 or the second wireless communication device 120 to determine the direction of the second wireless communication device 120. In some examples, this information may include GPS location information for the first wireless communication device 110 and/or the second wireless communication device 120.

In 330, the first wireless communication device 110 may output directions that enable a user of the first wireless communication device 110 to navigate to the second wireless communication device 120. In some embodiments, the directions may be an arrow displayed on the UI of an application running on the first wireless communication device 110. The directions may further include, but are not limited to, haptic feedback, audio-based directions and text-based direction. The directions may dynamically update based on the motion of the finder and/or the findee. Therefore, the operations performed in 325-330 may be performed continuously until the findee is located or the user of the finder discontinues attempting to locate the findee.

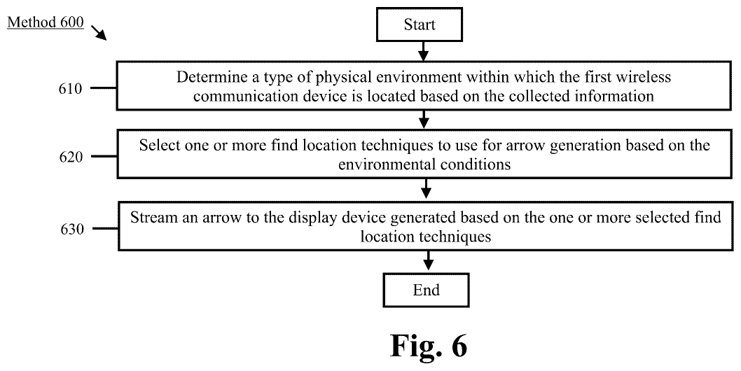

The finder may make a determination of a finding method based on the physical environment of the finder and/or findee. In one example, within the context of the method 300, prior to 325, the first wireless communication device 110 may determine whether the first wireless communication device 110 is in an outdoor or indoor location. In 325, when the first wireless communication device 110 is in an indoor setting, the first wireless communication device 110 may rely on at least UWB ranging without considering GPS information to determine the direction of the second wireless communication device 120 relative to the first wireless communication device 110. However, in 330, the output of directions may be limited to when the first wireless communication device 110 is within a range of (X) meters. When the first wireless communication device 110 is in an outdoor setting, the first wireless communication device 110 may rely on at least UWB ranging and GPS information to determine the direction of the second wireless communication device 120 relative to the first wireless communication device 110. However, in 330, the output of directions may be limited to when the first wireless communication device 110 is within a range of (Y) meters. The (Y) range threshold may be greater than the (X) range threshold because in this environment the use of GPS information allows for accurate location operations at larger distances than UWB without GPS information. These example techniques are discussed in more detail below with regard to the method 600 of FIG. 6.

In some example embodiments of FIG. 3, the ranging operations (e.g., UWB ranging) may be triggered by a discovery mechanism using Bluetooth including using Bluetooth advertisements. In other example embodiments, a discovery mechanism may be deployed over the Internet. The Internet-based discovery mechanism may be referred to herein as an Internet Discovery Service (IDS). In these example embodiments, a request may be sent from the finder device to the target device (or findee device) and, if the finder device receives a response from the target device, UWB ranging is triggered at the target device.

In still further example embodiments, a discovery mechanism may be deployed over a cellular connection. In these example embodiments, a request may be sent from the finder device to the target device (or findee device) using the cellular connection and, if the finder device receives a response from the target device, UWB ranging is triggered at the target device. Furthermore, other types of network connections may also be used to send/receive discovery messages to trigger the ranging operations.

In some example embodiments, the different types of discovery mechanisms (e.g., Bluetooth, IDS, cellular, etc.) may be used in combination. For example, two or more discovery mechanisms may be initiated in parallel and, if either of them is successful, the UWB ranging is triggered.

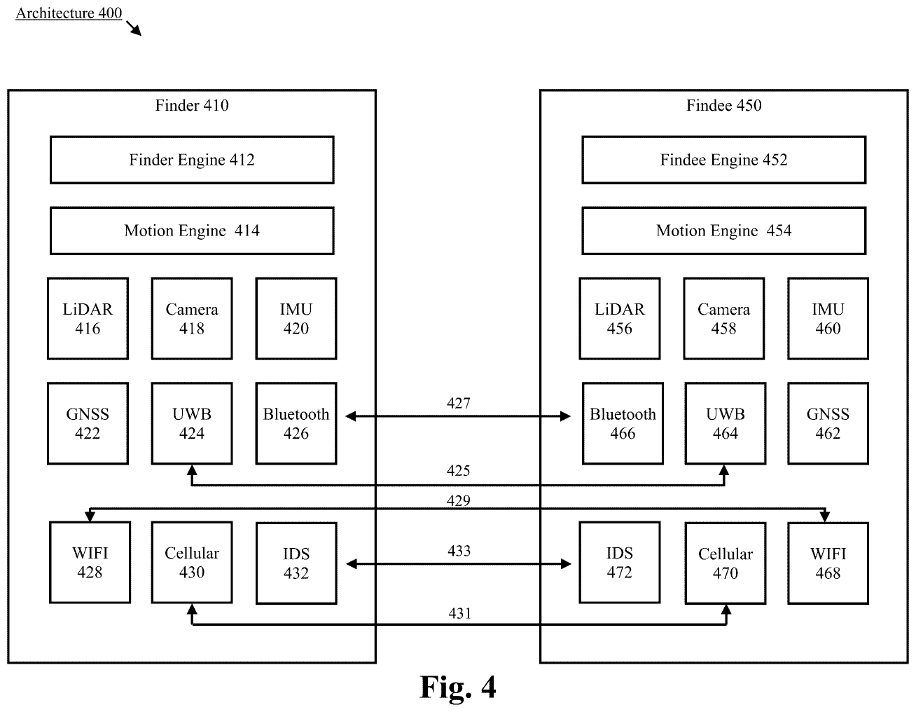

FIG. 4 shows an example architecture 400 for a finder 410 and findee 450 according to various example embodiments. The example architecture will be described with regard to the wireless communication device 200 of FIG. 2.

The architecture 400 provides a general example of the type of components that may interact with one another to enable a finder to locate a findee. The architecture 400 includes a finder 410 and the findee 450. Both the finder 410 and the findee 450 may be represent the wireless communication device 200 described above with regard to FIG. 2.

The finder 410 may include a finder engine 412, a motion engine 414, LiDAR 416, camera 418, inertial measurement unit (IMU) 420, global positioning system (GPS) 422, UWB 424, Bluetooth 426, WIFI 428, cellular 430, and IDS 432. The finder engine 412 may run on a processor and manage operations related to interacting with the user (e.g., receiving and responding to user input via a UI, etc.). In addition, the finder engine 412 may manage operations related to outputting directions to the user, e.g., directional arrow pointing towards the findee 450, haptic feedback directing the user to the findee 450, text-based feedback directing the user to the findee 450, etc.

The motion engine 414 may run on a processor and perform various operations related to deriving location information for the finder 410 and/or the findee 450. The motion engine 414 may receive input from, at least, the LiDAR 416, the camera 418, the IMU 420, the GPS 422, UWB 424, Bluetooth 426, WIFI 428, cellular 430, and IDS 432.

The motion engine 414 may perform operations such as, but not limited to, performing position estimates of the finder 410 and/or findee 450, performing a ranging estimate between the finder 410 and findee 450, performing time of flight measurements on signals exchanged with the findee 450, executing motion models, performing 3D mapping, object tracking and identifying a type of physical environment. In some examples, the motion engine 414 may use synthetic aperture techniques to derive information about the physical environment and location of the finder 410 and/or findee 450. In some examples, the motion engine 414 may use machine learning techniques to derive information about the physical environment and location of the finder 410 and/or findee 450.

WIFI 428 may represent hardware, software and/or firmware configured to communicate with an access point of a wireless local area network (WLAN). Information received from the WLAN or any other appropriate type of wireless network (e.g., cellular) may be used to determine a direction of the findee 450. However, the finder 410 does not require a network connection and may locate the findee 450 while offline. In some embodiments, information derived from a WLAN environment such as, but not limited to, WLAN or WIFI access point names (APNs) may also be used to determine a direction of the findee 450. Other information exchanged over the link 429 may include a request/response used to trigger the ranging operations.

Cellular 430 may represent hardware, software and/or firmware configured to communicate with a cellular network. Information received from the cellular network may be used to determine a direction of the findee 450. However, the finder 410 does not require a cellular network connection and may locate the findee 450 while offline. In some embodiments, information derived from a cellular environment such as, but not limited to, cell identifications (IDs), may also be used to determine a direction of the findee 450. Other information exchanged over the link 431 may include a request/response used to trigger the ranging operations.

Bluetooth 426 may represent hardware, software and/or firmware configured to perform short-range communication with the findee 450. This may include exchanging advertisements with the findee 450 over link 427 as described above with regard to the method 300.

UWB 424 may represent hardware, software and/or firmware configured to perform a ranging operation with the findee 450. This may include exchanging ranging data with the findee 450 over link 425. In some scenarios, the ranging operation may provide a more precise location of the findee 450.

GPS 422 may represent hardware, software and/or firmware configured to receive positioning information collected by satellites. The positioning information may correspond to the finder 410 and/or findee 450 and may be used to determine a direction of the findee 450. The information collected by the WIFI 428, cellular 430, IDS 432, Bluetooth 426, UWB 424 and GPS 422 may be provided to the motion engine 414.

LiDAR 416 may represent one or more LiDAR sensors comprising hardware, software and/or firmware configured to collect information about the physical surroundings and environment of the finder 410. Camera 418 may represent one or more camera comprising hardware, software and/or firmware configured to collect information about the physical surroundings and environment of the finder 410. Data collected using LiDAR 416 and/or camera 418 may be used for operations such as, but not limited to, three-dimensional mapping of a physical environment, tracking physical objects, deriving motion information of the finder 410 and deriving location information of the finder 410.

IMU 420 may represent one or more IMU sensors comprising hardware, software and/or firmware configured to collect information about the motion of the finder 410. The IMU 420 may collect data such as, but not limited to, acceleration measurements of the finder 410 and angular velocity measurements of the finder 410.

The findee 450 may include a findee engine 452, a motion engine 454, LiDAR 456, camera 458, IMU 460, GPS 462, UWB 464, Bluetooth 466, WIFI 468, cellular 470, and IDS 472. The findee engine 452 may run on a processor and manage operations related to interacting with the user (e.g., receiving and responding to user input via a UI, etc.). In some embodiments, there may be a reciprocal relationship between wireless communication devices and each device may simultaneously be a finder and a findee for one another.

The motion engine 454 may run on a processor and perform various operations related to deriving location information for the finder 410 and/or the findee 450. The motion engine 454 may receive input from, at least, the LiDAR 456, the camera 458, the IMU 460, the GPS 462, UWB 464, Bluetooth 466, WIFI 468, cellular 470, and IDS 472.

The motion engine 454 may perform operations such as, but not limited to, performing position estimates of the finder 410 and/or findee 450, performing a ranging estimate between the finder 410 and findee 450, performing time of flight measurements on signals exchanged with the finder 410, executing motion models, performing 3D mapping, object tracking and identifying a type of physical environment. In some examples, the motion engine 414 may use synthetic aperture techniques to derive information about the physical environment and location of the finder 410 and/or findee 450. In some examples, the motion engine 414 may use machine learning techniques to derive information about the physical environment and location of the finder 410 and/or findee 450.

WIFI 468 may represent hardware, software and/or firmware configured to communicate with an access point of a WLAN. The findee 450 may also be capable of communicating on other types of wireless networks (e.g., cellular, etc.). However, a network connection is not required and the findee 450 may be located while offline.

Bluetooth 466 may represent hardware, software and/or firmware configured to perform short-range communication with the finder 410. This may include exchanging advertisements with the finder 410 over link 427 as described above with regard to the method 300.

UWB 464 may represent hardware, software and/or firmware configured to perform a ranging operation with the finder 410. This may include exchanging ranging data with the finder 410 over link 425. In some scenarios, the ranging operation may provide a more precise location of the finder 410.

GPS 462 may represent hardware, software and/or firmware configured to receive positioning information collected by satellites. The positioning information may correspond to the finder 410 and/or findee 450. The information collected by the WIFI 468, cellular 470, IDS 472, Bluetooth 466, UWB 464 and GPS 462 may be provided to the motion engine 454. In addition, information collected by the WIFI 468, cellular 470, IDS 472, Bluetooth 466, UWB 464 and GPS 462 may be provided to the motion engine 454 may be provided to the finder 410 over the Bluetooth link 427, the UWB link 425 or in any other appropriate manner.

LIDAR 456 may represent one or more LiDAR sensors comprising hardware, software and/or firmware configured to collect information about the physical surroundings and environment of the findee 450. Camera 458 may represent one or more camera comprising hardware, software and/or firmware configured to collect information about the physical surroundings and environment of the findee 450. Data collected using LiDAR 456 and/or camera 458 may be used for operations such as, but not limited to, three-dimensional mapping of a physical environment, tracking physical objects, deriving motion information of the findee 450 and deriving location information of the findee 450.

IMU 460 may represent one or more IMU sensors comprising hardware, software and/or firmware configured to collect information about the motion of the finder 410. The IMU 460 may collect data such as, but not limited to, acceleration measurements of the finder 410 and angular velocity measurements of the finder 410. The information collected by the LiDAR 456, the camera 458 and the IMU 460 may be provided to the motion engine 454. In addition, the information collected by the LiDAR 456, camera 458 and the IMU 460 may be provided finder 410 over the Bluetooth link 427, the UWB link 425 or in any other appropriate manner.

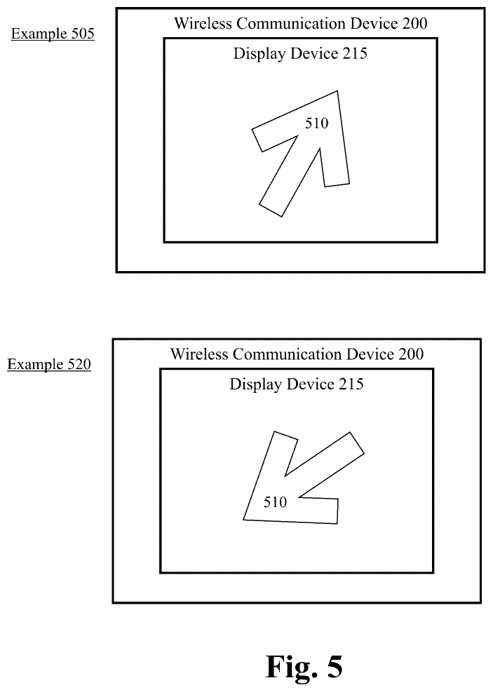

Examples of an arrow directing the finder to the findee according to various example embodiments is shown in FIG. 5. Example 505 shows a display device 215 of the communication device 200 at a first time. The communication device 200 is operating as a finder and its display device 215 shows a graphic of an arrow 510. The arrow 510 is configured to point in the direction of the findee relative to the location of the finder. This allows the user to walk towards the findee (or move towards the findee in any other manner). In this example, the arrow 510 is a 2D graphic. However, in an actual operating scenario the arrow may be a three-dimensional object and/or enhanced with additional graphics that provide further direction information that enables the user to navigate to the findee.

Example 520 shows a display device 215 of the communication device 200 at a second time that is subsequent to the first time. In between the first time of example 505 and the second time of example 520, at least one of the finder or the findee has moved. As a result, the arrow 510 has moved so that it is still pointing in the direction of the findee relative to the location of the finder. The examples shown in FIG. 5 are provided as a general example of the type of information that may be provided to the user to enable the user to navigate towards the findee. While the example embodiments are described with regard to arrow generation, the example techniques introduced herein may be used to generate any appropriate type of output (e.g., haptic feedback, static graphics, dynamic graphics, audio alerts, text alerts, lights, etc.) that is configured to enable a finder to locate a findee in a physical environment.

It has been identified that, for any of a variety of different reasons, an issue may occur that prevents the finder from displaying an accurate arrow (or any arrow at all). For instance, factors such as, indoor environments, GPS inaccuracies, crowded environments, distance between finder and findee, a lack of stationary objects, multi-path environments and occluding the view of the camera may lead to inaccurate or inadequate directions. Inaccurate and inadequate directions have a negative impact on the user experience associated with using the finder and findee functionality.

To limit the occurrence of inaccurate and inadequate directions, the finder may not provide explicit directions towards the findee until the finder is within a certain range of the findee. For example, the finder may not display an arrow pointing towards the findee until the finder is within a threshold range ((X) meters) of the findee. The example embodiments relate to adjusting the finder range threshold based on the physical environment.

FIG. 6 shows a method 600 for arrow generation according to various example embodiments. In this example, the method 600 may occur during the method 300 and is described from the perspective of the wireless communication device 110 operating as a finder and the wireless communication device 120 operating as the findee.

In 610, the first wireless communication device 110 determines a type of physical environment (e.g., type of physical environmental condition) within which the first wireless communication device 110, the second wireless communication device 120, or both, are located. The first wireless communication device 110 may make the determination based on the generated information as described below. In this example, the type of physical environment may be characterized as indoor or outdoor. However, this example is not intended to limit the example embodiments to any particular type of physical environment. In other examples, the type of physical environment may include indoor, outdoor and a combination of indoor and outdoor features. In further examples, the type of physical environment may be more specific, e.g., beach, park, open-field, restaurant, mall, office building, landmark, etc. In some examples, determining the type of physical environment may include determining one or more conditions of the physical environment (e.g., threshold of a condition). In some examples, the type of physical environment may indicate one or more conditions within the physical environment. A condition may include, for example, a density condition indicating a density of objects in the environment (e.g., people, trees, vehicles, buildings, etc.) Other conditions may include a weather condition, a lighting condition, etc. Other types of conditions may be considered.

In some examples, an object density condition may indicate a crowd density. This may include determining a number of people and/or objects located within a particular range or distance of the finder, the findee or both the finder and findee. In some embodiments, the first wireless communication device 110 may use computer vision and/or machine learning techniques to model its physical environment. The model may be a dynamic, real-time model that contains one or more particles. Each particle corresponding to a person or object in the physical environment and comprising one or more states including, but not limited to, two-dimensional coordinates in a two-dimensional coordinate system, three-dimensional coordinates in a three-dimensional system, velocity and direction of travel. The model may enable the first wireless communication device 110 to determine the type of physical environment in 610 and one or more conditions (e.g., crowd density). In some examples, the second wireless communication device 120 may use computer vision and/or machine learning techniques to model its physical environment and may transmit information related to its physical environment to the first wireless communication device 110.

In some examples, to determine a type of physical environment, the first wireless communication device 110 may generate information corresponding to one or more environmental conditions. An environmental condition may be indicated by a characteristic or parameter of a physical environment of the first wireless communication device 110, a second wireless communication device 120 (or both) such as, but not limited to, indoor features, outdoor features, single level, multi-level (e.g., multiple floors, multiple platforms, stadium seating, etc.), crowd density, a number of people, types of objects, a number of objects, a weather condition, etc.

The first wireless communication device 110 may generate information corresponding to one or more physical environmental conditions using one or more conditions or parameters of the physical environment. The first wireless communication device 110 may use its cameras and/or sensors (e.g., LiDAR, etc.) to generate the information. The second wireless communication device 120 may use its cameras and/or sensors (e.g., LiDAR, etc.) to generate such information and may transmit such information to the first wireless communication device 110. The first wireless communication device 110 may generate information corresponding to one or more physical environmental conditions at least in part by receiving and/or derive information about its environment from a local database comprising description information about the location of the first wireless communication device 110, the second wireless communication device 120 and/or any other appropriate remote source. The first wireless communication device 110 may also generate information corresponding to one or more environmental conditions at least in part by receiving signaling from the second wireless communication device 120 that includes information or parameters related to the environment of the first wireless communication device 110, the second wireless communication device 120 and/or any other appropriate remote source. The information may be provided as part of a Bluetooth advertisement, directly over a short-range connection or indirectly via a network connection. In some examples, the physical environment of the first wireless communication device 110 may be separate from the physical environment of the second wireless communication device 120. For example, the first wireless communication device 110 may be located indoors and the second wireless communication device 120 may be located outdoors. In some examples, the first wireless communication device 110 may collect, derive or receive the information corresponding to one or more physical environmental conditions.

In 620, the first wireless communication device 110 selects one or more find location techniques to use for arrow generation based on the determination of the type of physical environment).

The one or more find location techniques may include the type of information that is to provide the basis for the first wireless communication device 110 to determine the direction of the second wireless communication device 120. The one or more find location techniques may also include a range threshold relative to the findee within which the first wireless communication device 110 is to use this type of information to generate the arrow. The value of the range may be predetermined and configured at the first wireless communication device 110 or the first wireless communication device 110 may determine the threshold range based on algorithm or previous experiences with these types of environmental conditions.

To provide some examples, the first communication device 110 may be configured to identify different types of environments including, but not limited to, a beach, a park, a stadium, an amusement park, a particular neighborhood, an office, a house and a restaurant. The first communication device 110 may be configured to identify different types of conditions of the environment. In this example, the beach and the park may be associated with the highest range threshold (e.g., (3X) meters), the stadium, amusement park and neighborhood may be associated with the second highest range threshold (e.g., (2X) meters) while the office, home and restaurant may be associated with the smallest range threshold (e.g., (X) meters).

In other examples, the first communication device 110 may be configured to identify different crowd levels. In this example, each crowd level (e.g., low, medium, high, etc.) may be associated with a different range threshold. In this example, a low crowd density may be associated with the highest range threshold (e.g., (3Y) meters), a medium crowd density may be associated with the second highest range threshold (e.g., (2Y) meters) while a high crowd density may be associated with the smallest range threshold (e.g., (Y) meters). To determine a crowd level the first communication device 110 may compare a number of people to a threshold value. The threshold value may be the same for each type of physical environment or may vary depending on the type of physical environment.

In 630, the first wireless communication device 110 streams an arrow to its display device based on the selected one or more find location techniques. The first wireless communication device 110 may display an arrow on its display device based on the selected one or more find location techniques. The arrow may indicate a location of the first wireless communication device 110 relative to the second wireless communication device 120. The arrow may indicate where the findee is located relative to the finder. In some embodiments, the arrow may only be displayed when the first wireless communication device 110 is within the range threshold of the selected one or more find location techniques. The range threshold may be based on the type of physical environment, a condition of the physical environment, a crowd density and/or any other appropriate factor.

In some embodiments, when outside of the range threshold, the first wireless communication device 110 may not provide any directions to the user. In one non-limiting example, instead of directions, the first wireless communication device 110 may output a visual or audio indication that the second wireless communication device 120 is outside of range of the first wireless communication device 110. In other embodiments, when outside of the range threshold, the first wireless communication device 110 may provide general instructions instead of directions (e.g., far, near, closer, farther, etc.) that are intended to assist the finder to move within the range threshold.

The method 600 may be a continuous process that allows for incrementally estimating the pose of the finder relative to the location of the findee and thus, the angle or direction of the arrow. In addition, the first wireless communication device 110 may continuously evaluate environmental conditions and select a different one or more or more techniques to use for arrow generations if a change in environmental conditions is detected.

### EXAMPLES

In a first example, a method performed by an apparatus, comprising generating, for transmission to a wireless communication device, a request to initiate a ranging operation, processing, based on one or more signals received from the wireless communication device, a response indicating that the apparatus is to locate the second wireless communication device, determining information corresponding to physical environmental conditions of the apparatus or the wireless communication device and selecting one or more find location techniques to use for generating a graphic to be displayed on a display device based on at least the information corresponding to the physical environmental conditions of the apparatus or the wireless communication device, the graphic indicating a direction of the wireless communication device relative to the apparatus.

In a second example, the method of the first example, further comprising deriving the information corresponding to the physical environmental conditions of the apparatus, wherein the deriving includes a determination whether the apparatus is located indoors or outdoors.

In a third example, the method of the second example, wherein when the apparatus is located indoors, the selected one or more find location techniques includes at least ultra-wide band (UWB) ranging without the use of global positioning system (GPS) location information.

In a fourth example, the method of the second example, wherein when the apparatus is located outdoors, the selected one or more find location techniques includes at least ultra-wide band (UWB) ranging and the use of global positioning system (GPS) location information.

In a fifth example, the method of the second example, wherein deriving information corresponding to the physical environmental conditions of the apparatus includes a determination of a type of physical environment, the type of physical environment including at least a first type associated with a first range threshold and a second type associated with a second range threshold, wherein the first range threshold is larger than the second range threshold.

In a sixth example, the method of the fifth example, wherein the first type is an outdoor location and the second type is an indoor location.

In a seventh example, the method of the fifth example, wherein the first type is one of a beach and a park and the second type is one of an office, home or restaurant.

In an eighth example, the method of the fifth example, wherein the first type is a stadium, mall or amusement park and the second type is one of an office, home or restaurant.

In a ninth example, the method of the first example, wherein deriving information corresponding to the physical environmental conditions of the apparatus includes a determination of a crowd level, the crowd level including at least a first crowd level associated with a first range threshold and a second crowd level associated with a second range threshold, wherein the first range threshold is larger than the second range threshold.

In a tenth example, the method of the first example, wherein determining the information corresponding to the physical environmental conditions of the wireless communication device comprises a determination whether the wireless communication device is located indoors or outdoors.

In an eleventh example, the method of the tenth example, wherein when the wireless communication device is located indoors, the selected one or more find location techniques includes at least ultra-wide band (UWB) ranging without the use of global positioning system (GPS) location information.

In a twelfth example, the method of the tenth example, wherein when the wireless communication device is located outdoors, the selected one or more find location techniques includes at least ultra-wide band (UWB) ranging and the use of global positioning system (GPS) location information.

In a thirteenth example, the method of the first example, wherein determining information corresponding to the physical environmental conditions of the wireless communication device includes determining a type of physical environment, the type of physical environment including at least a first type associated with a first range threshold and a second type associated with a second range threshold, wherein the first range threshold is larger than the second range threshold.

In a fourteenth example, the method of the thirteenth example, wherein the first type is an outdoor location and the second type is an indoor location.

In a fifteenth example, the method of the thirteenth example, wherein the first type is one of a beach and a park and the second type is one of an office, home or restaurant.

In a sixteenth example, the method of the thirteenth example, wherein the first type is a stadium, mall or amusement park and the second type is one of an office, home or restaurant.

In a seventeenth example, the method of the first example, wherein determining information corresponding to the physical environmental conditions of the wireless communication device includes determining a crowd level, the crowd level including at least a first crowd level associated with a first range threshold and a second crowd level associated with a second range threshold, wherein the first range threshold is larger than the second range threshold.

In an eighteenth example, the method of the first example, wherein the graphic comprises an arrow.

In a nineteenth example, the method of the first example, wherein the request is transmitted via a short-rage connection, a Wi-Fi connection, an Internet connection or a cellular connection.

In a twentieth example, a processor configured to perform any of the methods of the first through nineteenth examples.

In a twenty first example, a wireless communication device configured to perform any of the methods of the first through nineteenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
generate, for transmission to a wireless communication device, a request to initiate a ranging operation;
process, based on one or more signals received from the wireless communication device, a response indicating that the apparatus is to locate the second wireless communication device;
determine information corresponding to physical environmental conditions of the apparatus or the wireless communication device; and
select one or more find location techniques to use for generating a graphic to be displayed on a display device based on at least the information corresponding to the physical environmental conditions of the apparatus or the wireless communication device, the graphic indicating a direction of the wireless communication device relative to the apparatus.

2. The apparatus of claim 1, wherein the processing circuitry is further configured to:
derive the information corresponding to the physical environmental conditions of the apparatus, wherein the deriving includes a determination whether the apparatus is located indoors or outdoors.

3. The apparatus of claim 2, wherein when the apparatus is located indoors, the selected one or more find location techniques includes at least ultra-wide band (UWB) ranging without the use of global positioning system (GPS) location information.

4. The apparatus of claim 2, wherein when the apparatus is located outdoors, the selected one or more find location techniques includes at least ultra-wide band (UWB) ranging and the use of global positioning system (GPS) location information.

5. The apparatus of claim 2, wherein deriving information corresponding to the physical environmental conditions of the apparatus includes a determination of a type of physical environment, the type of physical environment including at least a first type associated with a first range threshold and a second type associated with a second range threshold, wherein the first range threshold is larger than the second range threshold.

6. The apparatus of claim 5, wherein the first type is an outdoor location and the second type is an indoor location.

7. The apparatus of claim 5, wherein the first type is one of a beach and a park and the second type is one of an office, home or restaurant.

8. The apparatus of claim 5, wherein the first type is a stadium, mall or amusement park and the second type is one of an office, home or restaurant.

9. The apparatus of claim 1, wherein deriving information corresponding to the physical environmental conditions of the apparatus includes a determination of a crowd level, the crowd level including at least a first crowd level associated with a first range threshold and a second crowd level associated with a second range threshold, wherein the first range threshold is larger than the second range threshold.

10. The apparatus of claim 1, wherein determining the information corresponding to the physical environmental conditions of the wireless communication device comprises a determination whether the wireless communication device is located indoors or outdoors.

11. The apparatus of claim 10, wherein when the wireless communication device is located indoors, the selected one or more find location techniques includes at least ultra-wide band (UWB) ranging without the use of global positioning system (GPS) location information.

12. The apparatus of claim 10, wherein when the wireless communication device is located outdoors, the selected one or more find location techniques includes at least ultra-wide band (UWB) ranging and the use of global positioning system (GPS) location information.

13. The apparatus of claim 1, wherein determining information corresponding to the physical environmental conditions of the wireless communication device includes determining a type of physical environment, the type of physical environment including at least a first type associated with a first range threshold and a second type associated with a second range threshold, wherein the first range threshold is larger than the second range threshold.

14. The apparatus of claim 13, wherein the first type is an outdoor location and the second type is an indoor location.

15. The apparatus of claim 13, wherein the first type is one of a beach and a park and the second type is one of an office, home or restaurant.

16. The apparatus of claim 13, wherein the first type is a stadium, mall or amusement park and the second type is one of an office, home or restaurant.

17. The apparatus of claim 1, wherein determining information corresponding to the physical environmental conditions of the wireless communication device includes determining a crowd level, the crowd level including at least a first crowd level associated with a first range threshold and a second crowd level associated with a second range threshold, wherein the first range threshold is larger than the second range threshold.

18. The apparatus of claim 1, wherein the graphic comprises an arrow.

19. The apparatus of claim 1, wherein the request is transmitted via a short-rage connection, a Wi-Fi connection, an Internet connection or a cellular connection.

20. A method performed by an apparatus, comprising:
generating, for transmission to a wireless communication device, a request to initiate a ranging operation;
processing, based on one or more signals received from the wireless communication device, a response indicating that the apparatus is to locate the second wireless communication device;
determining information corresponding to physical environmental conditions of the apparatus or the wireless communication device; and
selecting one or more find location techniques to use for generating a graphic to be displayed on a display device based on at least the information corresponding to the physical environmental conditions of the apparatus or the wireless communication device, the graphic indicating a direction of the wireless communication device relative to the apparatus.
